(19) United States
(12) Patent Application Publication
(10) Pub. No.: US 2026/0069958 A1
(43) Pub. Date: Mar. 12, 2026

(54) SYSTEM

(71) Applicant: SoftBank Group Corp., Tokyo (JP)

(72) Inventor: Wataru NAKAJIMA, Tokyo (JP)

(21) Appl. No.: 19/317,284

(22) Filed: Sep. 3, 2025

(30) Foreign Application Priority Data
Sep. 10, 2024 (JP) 2024-156072

(51) Int. Cl. A63B 71/06; A63B 24/00; G06V 40/16; G06V 40/20; H04N 23/67

(52) U.S. Cl. CPC A63B 71/0622; A63B 24/0006; G06V 40/174; G06V 40/20; H04N 23/67; A63B 2024/0009; A63B 2208/02; A63B 2220/807; A63B 2230/62

(57) ABSTRACT

A system according to an embodiment comprises a camera unit, an analysis unit, and a provision unit. The camera unit captures the user's movements. The analysis unit analyzes data captured by the camera unit. The provision unit provides real-time advice based on the analysis results obtained by the analysis unit.

### CROSS-REFERENCE TO RELATED APPLICATION

The present application claims priority to and incorporates by reference the entire contents of Japanese Patent Application No. 2024-156072 filed in Japan on Sep. 10, 2024.

### BACKGROUND OF THE INVENTION

### Field of the Invention

The technology of this disclosure relates to a system.

### Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem in that the user's movements and posture are not sufficiently analyzed in real time and appropriate advice is not adequately provided.

### SUMMARY OF THE INVENTION

The system according to the embodiment comprises a camera unit, an analysis unit, and a provision unit. The camera unit captures the user's movements. The analysis unit analyzes data captured by the camera unit. The provision unit provides real-time advice based on the analysis results obtained by the analysis unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

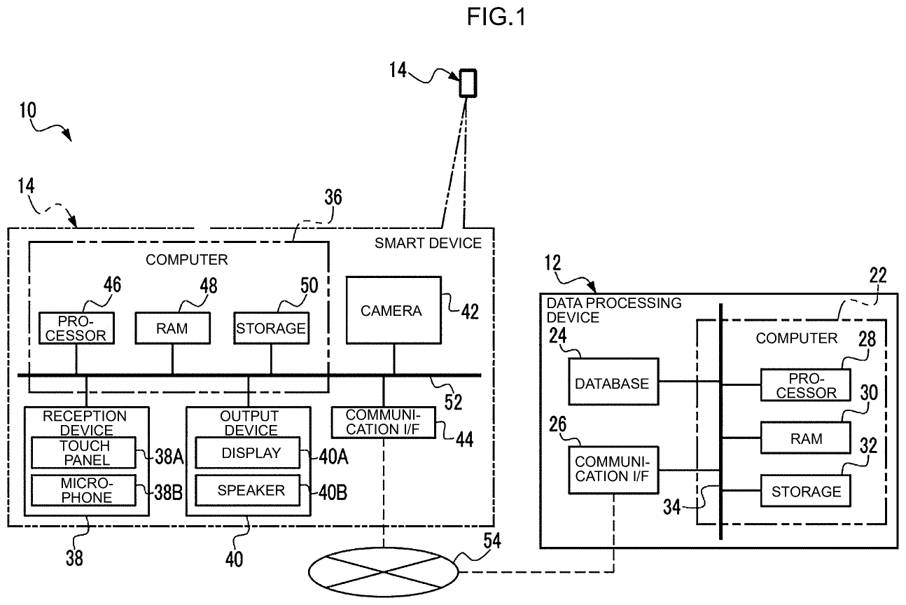

FIG. 1 shows an example configuration of a data processing system 10 according to the first embodiment. As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

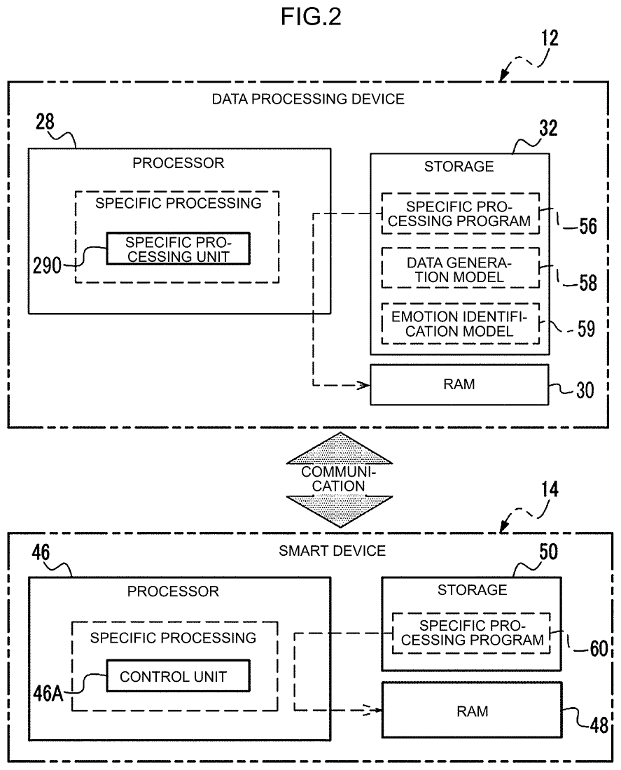

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The system according to the embodiment of the present invention is a system that allows users to experience the line of sight of top athletes or Living National Treasures using VR goggles. In this system, the user wears VR goggles and can experience the line of sight of top athletes or artisans. At this time, a camera built into the VR goggles captures the user's movements and posture in real time. Next, a generative AI analyzes the captured data and determines how the user's movements and posture differ from those of an expert. Finally, the generative AI provides real-time advice based on the analysis results. As a result, the user can learn the expert's techniques and improve their own movements. This service allows anyone to experience and learn top-level skills, which is useful for improving skills in sports and the arts. For example, the user wears VR goggles and experiences the line of sight of top athletes or artisans. For example, the user can watch a game from the perspective of an athlete or experience the process of creating a work from the perspective of an artisan. At this time, a camera built into the VR goggles captures the user's movements and posture in real time. Next, a generative AI analyzes the captured data and determines how the user's movements and posture differ from those of an expert. For example, from the athlete's perspective, the generative AI analyzes how the user's movement angles and timing differ from those of the expert. Finally, the generative AI provides real-time advice based on the analysis results. For example, the generative AI provides the user with specific advice such as “It would be better to raise the angle of your movement a little more” or “Make your hand movements a little smoother.” As a result, the user can learn the expert's techniques and improve their own movements. This service allows anyone to experience and learn top-level skills, which is useful for improving skills in sports and the arts. Thus, the system using VR goggles is useful for improving skills in sports and the arts, as it allows users to experience and learn top-level techniques.

The system according to the embodiment comprises a camera unit, an analysis unit, and a provision unit. The camera unit captures the user's movements. The camera unit can, for example, capture the user's movements or posture in real time. For example, the camera unit can capture the user's movements while walking. The camera unit can also capture the user's movements while running. The camera unit can also capture the user's posture when standing. For example, the camera unit can also capture the user's posture when sitting. The analysis unit analyzes the captured data. The analysis unit can, for example, determine how the user's movements or posture differ from those of an expert. For example, the analysis unit can analyze how the user's movement angles and timing differ from those of an expert. The analysis unit can also analyze how the user's movement speed and rhythm differ from those of an expert. The analysis unit can also analyze how the user's posture stability and balance differ from those of an expert. The provision unit provides real-time advice based on the analysis results. The provision unit can, for example, provide the user with specific advice such as “It would be better to raise the angle of your movement a little more” or “Make your hand movements a little smoother.” The provision unit can also provide the user with advice such as “Move a little faster” or “Stabilize your posture balance a little more.” Thus, the system according to the embodiment supports the user's skill improvement by capturing, analyzing, and providing advice on the user's movements in real time.

The camera unit can capture the user's movements or posture in real time. The camera unit can, for example, capture the user's movements in real time. For example, the camera unit can capture the user's movements while walking. The camera unit can also capture the user's movements while running. The camera unit can also capture the user's posture when standing. For example, the camera unit can also capture the user's posture when sitting. By capturing the user's movements or posture in real time, accurate data can be obtained. Some or all of the above-described processing in the camera unit may be performed using AI, or may be performed without using AI. For example, the camera unit can input the data of the user's captured movements to a generative AI, and the generative AI can analyze the data.

The analysis unit can analyze the captured data and determine how the user's movements or posture differ from those of an expert. The analysis unit can, for example, analyze the captured data and determine how the user's movements or posture differ from those of an expert. For example, the analysis unit can analyze how the user's movement angles and timing differ from those of an expert. The analysis unit can also analyze how the user's movement speed and rhythm differ from those of an expert. The analysis unit can also analyze how the user's posture stability and balance differ from those of an expert. By determining how the user's movements or posture differ from those of an expert, specific points for improvement can be identified. Some or all of the above-described processing in the analysis unit may be performed using generative AI, or may be performed without using generative AI. For example, the analysis unit can input the captured data to a generative AI, and the generative AI can analyze the data.

The provision unit can provide real-time advice based on the analysis results. The provision unit can, for example, provide real-time advice based on the analysis results. For example, the provision unit can provide the user with specific advice such as “It would be better to raise the angle of your movement a little more” or “Make your hand movements a little smoother.” The provision unit can also provide the user with advice such as “Move a little faster” or “Stabilize your posture balance a little more.” By providing advice in real time, the user can immediately grasp points for improvement. Some or all of the above-described processing in the provision unit may be performed using generative AI, or may be performed without using generative AI. For example, the provision unit can input the analysis results to a generative AI, and the generative AI can generate advice.

The provision unit can provide the user with specific advice content. The provision unit can, for example, provide the user with specific advice content. For example, the provision unit can provide the user with specific advice such as “It would be better to raise the angle of your movement a little more” or “Make your hand movements a little smoother.” The provision unit can also provide the user with advice such as “Move a little faster” or “Stabilize your posture balance a little more.” By providing specific advice, the user can understand concrete ways to improve. Some or all of the above-described processing in the provision unit may be performed using generative AI, or may be performed without using generative AI. For example, the provision unit can input the analysis results to a generative AI, and the generative AI can generate advice.

The system comprises a camera unit that analyzes the user's past operation history and selects an appropriate capture timing. The camera unit can, for example, analyze the user's past operation history and select an appropriate capture timing. For example, the timing of actions previously performed by the user is analyzed, and capturing is started at the timing when similar actions are performed. The frequency of specific actions performed by the user in the past can also be analyzed, and the capture timing can be adjusted based on that frequency. The start and end timing of actions can also be predicted based on the user's past operation history, and the optimal capture timing can be selected. By selecting the optimal capture timing based on past operation history, important moments can be captured without missing them. Some or all of the above-described processing in the camera unit may be performed using AI, or may be performed without using AI. For example, the camera unit can input the user's past operation history to a generative AI, and the generative AI can select the optimal capture timing.

The system comprises a camera unit that emphasizes and captures specific movements or postures when capturing the user's movements. The camera unit can, for example, emphasize and capture specific movements or postures when capturing the user's movements. For example, when the user performs a specific action, the camera's focus is adjusted to emphasize and capture that action. The camera's zoom function can also be used to emphasize and capture a specific posture when the user takes that posture. The camera's exposure can also be adjusted to emphasize and capture a specific action when the user performs it. By emphasizing and capturing specific movements or postures, important actions can be analyzed in detail. Some or all of the above-described processing in the camera unit may be performed using AI, or may be performed without using AI. For example, the camera unit can input the data of the user's captured movements to a generative AI, and the generative AI can emphasize and capture specific movements or postures.

The system comprises a camera unit that prioritizes capturing actions with high relevance by considering the user's geographic location information. The camera unit can, for example, prioritize capturing actions with high relevance by considering the user's geographic location information. For example, if the user is at a specific sports facility, actions related to that sport are prioritized for capture. If the user is at a specific workshop, technical actions performed at that workshop can also be prioritized for capture. If the user is at a specific event venue, actions related to that event can also be prioritized for capture. By considering geographic location information, actions with high relevance can be prioritized for capture. Some or all of the above-described processing in the camera unit may be performed using AI, or may be performed without using AI. For example, the camera unit can input the user's geographic location information to a generative AI, and the generative AI can select actions with high relevance.

The system comprises a camera unit that analyzes the user's social media activity and captures related actions. The camera unit can, for example, analyze the user's social the user's shared videos or photos on social media are analyzed, and related actions are captured. The activity of accounts followed by the user on social media can also be analyzed, and related actions can be captured. Events in which the user participates on social media can also be analyzed, and related actions can be captured. By analyzing social media activity, actions related to the user can be captured. Some or all of the above-described processing in the camera unit may be performed using AI, or may be performed without using AI. For example, the camera unit can input the user's social media activity to a generative AI, and the generative AI can select related actions.

The analysis unit can adjust the level of detail of the analysis based on the importance of the action when analyzing the captured data. The analysis unit can, for example, adjust the level of detail of the analysis based on the importance of the action when analyzing the captured data. For example, detailed analysis is performed for important actions, and detailed analysis results are provided. For actions of low importance, simplified analysis can be performed and basic analysis results can be provided. The level of detail of the analysis can also be adjusted stepwise according to the importance of the action to provide appropriate analysis results. By adjusting the level of detail of the analysis based on the importance of the action, important actions can be analyzed in detail. Some or all of the above-described processing in the analysis unit may be performed using generative AI, or may be performed without using generative AI. For example, the analysis unit can input the captured data to a generative AI, and the generative AI can adjust the level of detail of the analysis based on the importance of the action.

The analysis unit can apply different analysis algorithms according to the category of the action when analyzing the captured data. The analysis unit can, for example, apply different analysis algorithms according to the category of the action when analyzing the captured data. For example, a sports-specific analysis algorithm is applied to sports actions. A craft-specific analysis algorithm can also be applied to craft actions. An art-specific analysis algorithm can also be applied to art actions. By applying different analysis algorithms according to the category of the action, more appropriate analysis results can be provided. Some or all of the above-described processing in the analysis unit may be performed using generative AI, or may be performed without using generative AI. For example, the analysis unit can input the captured data to a generative AI, and the generative AI can apply different analysis algorithms according to the category of the action.

The analysis unit can determine the priority of analysis based on the submission timing of the action when analyzing the captured data. The analysis unit can, for example, determine the priority of analysis based on the submission timing of the action when analyzing the captured data. For example, recently captured data is prioritized for analysis, and the latest analysis results are provided. The priority of analysis can be lowered for data with an older submission timing. The priority of analysis can also be adjusted stepwise based on the submission timing to provide appropriate analysis results. By determining the priority of analysis based on the submission timing, the latest data can be prioritized for analysis. Some or all of the above-described processing in the analysis unit may be performed using generative AI, or may be performed without using generative AI. For example, the analysis unit can input the captured data to a generative AI, and the generative AI can determine the priority of analysis based on the submission timing of the action.

The analysis unit can adjust the order of analysis based on the relevance of the action when analyzing the captured data. The analysis unit can, for example, adjust the order of analysis based on the relevance of the action when analyzing the captured data. For example, actions with high relevance are prioritized for analysis, and detailed analysis results are provided. The order of analysis can be postponed for actions with low relevance. The order of analysis can also be adjusted stepwise based on the relevance of the action to provide appropriate analysis results. By adjusting the order of analysis based on the relevance of the action, actions with high relevance can be prioritized for analysis. Some or all of the above-described processing in the analysis unit may be performed using generative AI, or may be performed without using generative AI. For example, the analysis unit can input the captured data to a generative AI, and the generative AI can adjust the order of analysis based on the relevance of the action.

The provision unit can adjust the level of detail of advice based on the importance of the advice when providing advice based on the analysis results. The provision unit can, for example, adjust the level of detail of advice based on the importance of the advice when providing advice based on the analysis results. For important advice, advice containing detailed information is provided. For advice of low importance, advice containing simplified information can be provided. The level of detail can also be adjusted stepwise according to the importance of the advice to provide appropriate advice. By adjusting the level of detail of advice based on the importance of the advice, important advice can be provided in detail. Some or all of the above-described processing in the provision unit may be performed using generative AI, or may be performed without using generative AI. For example, the provision unit can input the analysis results to a generative AI, and the generative AI can adjust the level of detail of advice based on the importance of the advice.

The provision unit can apply different advice algorithms according to the category of the action when providing advice based on the analysis results. The provision unit can, for example, apply different advice algorithms according to the category of the action when providing advice based on the analysis results. For example, a sports-specific advice algorithm is applied to sports actions. A craft-specific advice algorithm can also be applied to craft actions. An art-specific advice algorithm can also be applied to art actions. By applying different advice algorithms according to the category of the action, more appropriate advice can be provided. Some or all of the above-described processing in the provision unit may be performed using generative AI, or may be performed without using generative AI. For example, the provision unit can input the analysis results to a generative AI, and the generative AI can apply different advice algorithms according to the category of the action.

The provision unit can determine the priority of advice based on the submission timing of the action when providing advice based on the analysis results. The provision unit can, for example, determine the priority of advice based on the submission timing of the action when providing advice based on the analysis results. For example, advice based on recently captured data is provided with priority. The priority can be lowered for advice based on data with an older submission timing. The priority of advice can also be adjusted stepwise based on the submission timing to provide appropriate advice. By determining the priority of advice based on the submission timing, advice based on the latest data can be provided with priority. Some or all of the above-described processing in the provision unit may be performed using generative AI, or may be performed without using generative AI. For example, the provision unit can input the analysis results to a generative AI, and the generative AI can determine the priority of advice based on the submission timing of the action.

The provision unit can adjust the order of advice based on the relevance of the action when providing advice based on the analysis results. The provision unit can, for example, adjust the order of advice based on the relevance of the action when providing advice based on the analysis results. For example, advice for actions with high relevance is provided with priority. The order can be postponed for advice for actions with low relevance. The order of advice can also be adjusted stepwise based on the relevance of the action to provide appropriate advice. By adjusting the order of advice based on the relevance of the action, advice for actions with high relevance can be provided with priority. Some or all of the above-described processing in the provision unit may be performed using generative AI, or may be performed without using generative AI. For example, the provision unit can input the analysis results to a generative AI, and the generative AI can adjust the order of advice based on the relevance of the action.

The system according to the embodiment is not limited to the above-described examples, and various modifications are possible, for example, as follows.

The system may comprise an audio capture unit that records environmental sounds simultaneously when capturing the user's actions. For example, the sounds around the user while playing sports are recorded and the audio data is analyzed together with the motion analysis. The sounds of tools while the user is performing craft work can also be recorded and used to analyze the accuracy and rhythm of the actions. The sounds of instruments while the user is performing music can also be recorded and used to improve performance skills. By combining and analyzing motion and audio data, more detailed feedback can be provided.

The system may comprise an environmental sensor unit that records environmental data such as temperature and humidity simultaneously when capturing the user's actions. For example, the temperature and humidity around the user while playing sports are recorded and the environmental data is analyzed together with the motion analysis. The temperature and humidity of the work environment while the user is performing craft work can also be recorded and used to analyze factors affecting work efficiency and accuracy. The temperature and humidity of the performance environment while the user is performing music can also be recorded and used to improve performance skills. By combining and analyzing motion and environmental data, more detailed feedback can be provided.

The system may comprise a biometric sensor unit that records biometric data such as heart rate and respiration rate simultaneously when capturing the user's actions. For example, the user's heart rate and respiration rate while playing sports are recorded and the biometric data is analyzed together with the motion analysis. The user's heart rate and respiration rate while performing craft work can also be recorded and used to analyze the degree of concentration and fatigue. The user's heart rate and respiration rate while performing music can also be recorded and used to improve performance skills. By combining and analyzing motion and biometric data, more detailed feedback can be provided.

The system may comprise an eye-tracking unit that records the user's gaze movements simultaneously when capturing the user's actions. For example, the user's gaze movements while playing sports are recorded and the gaze data is analyzed together with the motion analysis. The user's gaze movements while performing craft work can also be recorded and used to analyze the degree of concentration and gaze movement patterns. The user's gaze movements while performing music can also be recorded and used to improve performance skills. By combining and analyzing motion and gaze data, more detailed feedback can be provided.

The system may comprise an electromyography (EMG) sensor unit that records the user's muscle potentials simultaneously when capturing the user's actions. For example, the user's muscle potentials while playing sports are recorded and the EMG data is analyzed together with the motion analysis. The user's muscle potentials while performing craft work can also be recorded and used to analyze the accuracy and force applied during work. The user's muscle potentials while performing music can also be recorded and used to improve performance skills. By combining and analyzing motion and EMG data, more detailed feedback can be provided.

Below, the processing flow of Example 1 of the Embodiment will be briefly described.

Step 1: The camera unit captures the user's movements. The camera unit can, for example, capture the user's movements or posture in real time. For example, the camera unit can capture the user's movements while walking. The camera unit can also capture the user's movements while running. The camera unit can also capture the user's posture when standing. For example, the camera unit can also capture the user's posture when sitting.

Step 2: The analysis unit analyzes the captured data. The analysis unit can, for example, determine how the user's movements or posture differ from those of an expert. For example, the analysis unit can analyze how the user's movement angles and timing differ from those of an expert. The analysis unit can also analyze how the user's movement speed and rhythm differ from those of an expert. The analysis unit can also analyze how the user's posture stability and balance differ from those of an expert. Step 3: The provision unit provides real-time advice based on the analysis results. The provision unit can, for example, provide the user with specific advice such as “It would be better to raise the angle of your movement a little more” or “Make your hand movements a little smoother.” The provision unit can also provide the user with advice such as “Move a little faster” or “Stabilize your posture balance a little more.”

### Example 2 of the Embodiment

The system according to the embodiment of the present invention is a system that allows users to experience the line of sight of top athletes or Living National Treasures using VR goggles. In this system, the user wears VR goggles and can experience the line of sight of top athletes or artisans. At this time, a camera built into the VR goggles captures the user's movements and posture in real time. Next, a generative AI analyzes the captured data and determines how the user's movements and posture differ from those of an expert. Finally, the generative AI provides real-time advice based on the analysis results. As a result, the user can learn the expert's techniques and improve their own movements. This service allows anyone to experience and learn top-level skills, which is useful for improving skills in sports and the arts. For example, the user wears VR goggles and experiences the line of sight of top athletes or artisans. For example, the user can watch a game from the perspective of an athlete or experience the process of creating a work from the perspective of an artisan. At this time, a camera built into the VR goggles captures the user's movements and posture in real time. Next, a generative AI analyzes the captured data and determines how the user's movements and posture differ from those of an expert. For example, from the athlete's perspective, the generative AI analyzes how the user's movement angles and timing differ from those of the expert. Finally, the generative AI provides real-time advice based on the analysis results. For example, the generative AI provides the user with specific advice such as “It would be better to raise the angle of your movement a little more” or “Make your hand movements a little smoother.” As a result, the user can learn the expert's techniques and improve their own movements. This service allows anyone to experience and learn top-level skills, which is useful for improving skills in sports and the arts. Thus, the system using VR goggles is useful for improving skills in sports and the arts, as it allows users to experience and learn top-level techniques.

The system according to the embodiment comprises a camera unit, an analysis unit, and a provision unit. The camera unit captures the user's movements. The camera unit can, for example, capture the user's movements or posture in real time. For example, the camera unit can capture the user's movements while walking. The camera unit can also capture the user's movements while running. The camera unit can also capture the user's posture when standing. For example, the camera unit can also capture the user's posture when sitting. The analysis unit analyzes the captured data. The analysis unit can, for example, determine how the user's movements or posture differ from those of an expert. For example, the analysis unit can analyze how the user's movement angles and timing differ from those of an expert. The analysis unit can also analyze how the user's movement speed and rhythm differ from those of an expert. The analysis unit can also analyze how the user's posture stability and balance differ from those of an expert. The provision unit provides real-time advice based on the analysis results. The provision unit can, for example, provide the user with specific advice such as “It would be better to raise the angle of your movement a little more” or “Make your hand movements a little smoother.” The provision unit can also provide the user with advice such as “Move a little faster” or “Stabilize your posture balance a little more.” Thus, the system according to the embodiment supports the user's skill improvement by capturing, analyzing, and providing advice on the user's movements in real time.

The camera unit can capture the user's movements or posture in real time. The camera unit can, for example, capture the user's movements in real time. For example, the camera unit can capture the user's movements while walking. The camera unit can also capture the user's movements while running. The camera unit can also capture the user's posture when standing. For example, the camera unit can also capture the user's posture when sitting. By capturing the user's movements or posture in real time, accurate data can be obtained. Some or all of the above-described processing in the camera unit may be performed using AI, or may be performed without using AI. For example, the camera unit can input the data of the user's captured movements to a generative AI, and the generative AI can analyze the data.

The analysis unit can analyze the captured data and determine how the user's movements or posture differ from those of an expert. The analysis unit can, for example, analyze the captured data and determine how the user's movements or posture differ from those of an expert. For example, the analysis unit can analyze how the user's movement angles and timing differ from those of an expert. The analysis unit can also analyze how the user's movement speed and rhythm differ from those of an expert. The analysis unit can also analyze how the user's posture stability and balance differ from those of an expert. By determining how the user's movements or posture differ from those of an expert, specific points for improvement can be identified. Some or all of the above-described processing in the analysis unit may be performed using generative AI, or may be performed without using generative AI. For example, the analysis unit can input the captured data to a generative AI, and the generative AI can analyze the data.

The provision unit can provide real-time advice based on the analysis results. The provision unit can, for example, provide real-time advice based on the analysis results. For example, the provision unit can provide the user with specific advice such as “It would be better to raise the angle of your movement a little more” or “Make your hand movements a little smoother.” The provision unit can also provide the user with advice such as “Move a little faster” or “Stabilize your posture balance a little more.” By providing advice in real time, the user can immediately grasp points for improvement. Some or all of the above-described processing in the provision unit may be performed using generative AI, or may be performed without using generative AI. For example, the provision unit can input the analysis results to a generative AI, and the generative AI can generate advice.

The provision unit can provide the user with specific advice content. The provision unit can, for example, provide the user with specific advice content. For example, the provision unit can provide the user with specific advice such as “It would be better to raise the angle of your movement a little more” or “Make your hand movements a little smoother.” The provision unit can also provide the user with advice such as “Move a little faster” or “Stabilize your posture balance a little more.” By providing specific advice, the user can understand concrete ways to improve. Some or all of the above-described processing in the provision unit may be performed using generative AI, or may be performed without using generative AI. For example, the provision unit can input the analysis results to a generative AI, and the generative AI can generate advice.

The system comprises a camera unit that estimates the user's emotions and adjusts the camera's capture angle based on the estimated emotions of the user. The camera unit can, for example, estimate the user's emotions and adjust the camera's capture angle based on the estimated emotions. For example, if the user is nervous, the camera's capture angle is widened to capture the overall movement. If the user is relaxed, the camera's capture angle can be narrowed to capture detailed movements. If the user is focused, the capture angle can be adjusted to focus on specific movements or postures. By adjusting the capture angle according to the user's emotions, more appropriate data can be obtained. Emotion estimation is realized, for example, by using an emotion engine or a generative AI as an emotion estimation function. The generative AI may be, for example, a text generative AI (such as an LLM) or a multimodal generative AI, but is not limited to such examples. Some or all of the above-described processing in the camera unit may be performed using AI, or may be performed without using AI. For example, the camera unit can input data for estimating the user's emotions to a generative AI, and the generative AI can estimate the emotions and adjust the capture angle based on the results.

The system comprises a camera unit that analyzes the user's past operation history and selects an appropriate capture timing. The camera unit can, for example, analyze the user's past operation history and select an appropriate capture timing. For example, the timing of actions previously performed by the user is analyzed, and capturing is started at the timing when similar actions are performed. The frequency of specific actions performed by the user in the past can also be analyzed, and the capture timing can be adjusted based on that frequency. The start and end timing of actions can also be predicted based on the user's past operation history, and the optimal capture timing can be selected. By selecting the optimal capture timing based on past operation history, important moments can be captured without missing them. Some or all of the above-described processing in the camera unit may be performed using AI, or may be performed without using AI. For example, the camera unit can input the user's past operation history to a generative AI, and the generative AI can select the optimal capture timing.

The system comprises a camera unit that emphasizes and captures specific movements or postures when capturing the user's movements. The camera unit can, for example, emphasize and capture specific movements or postures when capturing the user's movements. For example, when the user performs a specific action, the camera's focus is adjusted to emphasize and capture that action. The camera's zoom function can also be used to emphasize and capture a specific posture when the user takes that posture. The camera's exposure can also be adjusted to emphasize and capture a specific action when the user performs it. By emphasizing and capturing specific movements or postures, important actions can be analyzed in detail. Some or all of the above-described processing in the camera unit may be performed using AI, or may be performed without using AI. For example, the camera unit can input the data of the user's captured movements to a generative AI, and the generative AI can emphasize and capture specific movements or postures.

The system comprises a camera unit that estimates the user's emotions and determines the priority of actions to be captured based on the estimated emotions of the user. The camera unit can, for example, estimate the user's emotions and determine the priority of actions to be captured based on the estimated emotions. For example, if the user is excited, the priority of actions to be captured is determined with an emphasis on the sense of speed. If the user is relaxed, the priority of actions to be captured can be determined with an emphasis on smoothness. If the user is focused, the priority of actions to be captured can be determined with an emphasis on specific technical actions. By determining the priority of actions to be captured according to the user's emotions, important actions can be captured preferentially. Emotion estimation is realized, for example, by using an emotion engine or a generative AI as an emotion estimation function. The generative AI may be, for example, a text generative AI (such as an LLM) or a multimodal generative AI, but is not limited to such examples. Some or all of the above-described processing in the camera unit may be performed using AI, or may be performed without using AI. For example, the camera unit can input data for estimating the user's emotions to a generative AI, and the generative AI can estimate the emotions and determine the priority of actions to be captured based on the results.

The system comprises a camera unit that prioritizes capturing actions with high relevance by considering the user's geographic location information. The camera unit can, for example, prioritize capturing actions with high relevance by considering the user's geographic location information. For example, if the user is at a specific sports facility, actions related to that sport are prioritized for capture. If the user is at a specific workshop, technical actions performed at that workshop can also be prioritized for capture. If the user is at a specific event venue, actions related to that event can also be prioritized for capture. By considering geographic location information, actions with high relevance can be prioritized for capture. Some or all of the above-described processing in the camera unit may be performed using AI, or may be performed without using AI. For example, the camera unit can input the user's geographic location information to a generative AI, and the generative AI can select actions with high relevance.

The system comprises a camera unit that analyzes the user's social media activity and captures related actions. The camera unit can, for example, analyze the user's social the user's shared videos or photos on social media are analyzed, and related actions are captured. The activity of accounts followed by the user on social media can also be analyzed, and related actions can be captured. Events in which the user participates on social media can also be analyzed, and related actions can be captured. By analyzing social media activity, actions related to the user can be captured. Some or all of the above-described processing in the camera unit may be performed using AI, or may be performed without using AI. For example, the camera unit can input the user's social media activity to a generative AI, and the generative AI can select related actions.

The system comprises an analysis unit that estimates the user's emotions and adjusts the analysis algorithm based on the estimated emotions of the user. The analysis unit can, for example, estimate the user's emotions and adjust the analysis algorithm based on the estimated emotions. For example, if the user is nervous, the analysis algorithm is simplified and focuses on the analysis of basic actions. If the user is relaxed, the analysis algorithm can be made more detailed and focus on the analysis of detailed actions. If the user is focused, the analysis algorithm can be made more advanced and focus on the analysis of technical actions. By adjusting the analysis algorithm according to the user's emotions, more appropriate analysis results can be provided. Emotion estimation is realized, for example, by using an emotion engine or a generative AI as an emotion estimation function. The generative AI may be, for example, a text generative AI (such as an LLM) or a multimodal generative AI, but is not limited to such examples. Some or all of the above-described processing in the analysis unit may be performed using generative AI, or may be performed without using generative AI. For example, the analysis unit can input data for estimating the user's emotions to a generative AI, and the generative AI can estimate the emotions and adjust the analysis algorithm based on the results.

The analysis unit can adjust the level of detail of the analysis based on the importance of the action when analyzing the captured data. The analysis unit can, for example, adjust the level of detail of the analysis based on the importance of the action when analyzing the captured data. For example, detailed analysis is performed for important actions, and detailed analysis results are provided. For actions of low importance, simplified analysis can be performed and basic analysis results can be provided. The level of detail of the analysis can also be adjusted stepwise according to the importance of the action to provide appropriate analysis results. By adjusting the level of detail of the analysis based on the importance of the action, important actions can be analyzed in detail. Some or all of the above-described processing in the analysis unit may be performed using generative AI, or may be performed without using generative AI. For example, the analysis unit can input the captured data to a generative AI, and the generative AI can adjust the level of detail of the analysis based on the importance of the action.

The analysis unit can apply different analysis algorithms according to the category of the action when analyzing the captured data. The analysis unit can, for example, apply different analysis algorithms according to the category of the action when analyzing the captured data. For example, a sports-specific analysis algorithm is applied to sports actions. A craft-specific analysis algorithm can also be applied to craft actions. An art-specific analysis algorithm can also be applied to art actions. By applying different analysis algorithms according to the category of the action, more appropriate analysis results can be provided. Some or all of the above-described processing in the analysis unit may be performed using generative AI, or may be performed without using generative AI. For example, the analysis unit can input the captured data to a generative AI, and the generative AI can apply different analysis algorithms according to the category of the action.

The system comprises an analysis unit that estimates the user's emotions and adjusts the display method of the analysis results based on the estimated emotions of the user. The analysis unit can, for example, estimate the user's emotions and adjust the display method of the analysis results based on the estimated emotions. For example, if the user is nervous, a simple and highly visible display method is provided. If the user is relaxed, a display method including detailed information can be provided. If the user is focused, a display method including technical details can be provided. By adjusting the display method of the analysis results according to the user's emotions, more appropriate information can be provided. Emotion estimation is realized, for example, by using an emotion engine or a generative AI as an emotion estimation function. The generative AI may be, for example, a text generative AI (such as an LLM) or a multimodal generative AI, but is not limited to such examples. Some or all of the above-described processing in the analysis unit may be performed using generative AI, or may be performed without using generative AI. For example, the analysis unit can input data for estimating the user's emotions to a generative AI, and the generative AI can estimate the emotions and adjust the display method of the analysis results based on the results.

The analysis unit can determine the priority of analysis based on the submission timing of the action when analyzing the captured data. The analysis unit can, for example, determine the priority of analysis based on the submission timing of the action when analyzing the captured data. For example, recently captured data is prioritized for analysis, and the latest analysis results are provided. The priority of analysis can be lowered for data with an older submission timing. The priority of analysis can also be adjusted stepwise based on the submission timing to provide appropriate analysis results. By determining the priority of analysis based on the submission timing, the latest data can be prioritized for analysis. Some or all of the above-described processing in the analysis unit may be performed using generative AI, or may be performed without using generative AI. For example, the analysis unit can input the captured data to a generative AI, and the generative AI can determine the priority of analysis based on the submission timing of the action.

The analysis unit can adjust the order of analysis based on the relevance of the action when analyzing the captured data. The analysis unit can, for example, adjust the order of analysis based on the relevance of the action when analyzing the captured data. For example, actions with high relevance are prioritized for analysis, and detailed analysis results are provided. The order of analysis can be postponed for actions with low relevance. The order of analysis can also be adjusted stepwise based on the relevance of the action to provide appropriate analysis results. By adjusting the order of analysis based on the relevance of the action, actions with high relevance can be prioritized for analysis. Some or all of the above-described processing in the analysis unit may be performed using generative AI, or may be performed without using generative AI. For example, the analysis unit can input the captured data to a generative AI, and the generative AI can adjust the order of analysis based on the relevance of the action.

The system comprises a provision unit that estimates the user's emotions and adjusts the expression method of advice based on the estimated emotions of the user. The provision unit can, for example, estimate the user's emotions and adjust the expression method of advice based on the estimated emotions. For example, if the user is nervous, simple and highly visible advice is provided. If the user is relaxed, advice including detailed information can be provided. If the user is focused, advice including technical details can be provided. By adjusting the expression method of advice according to the user's emotions, more appropriate advice can be provided. Emotion estimation is realized, for example, by using an emotion engine or a generative AI as an emotion estimation function. The generative AI may be, for example, a text generative AI (such as an LLM) or a multimodal generative AI, but is not limited to such examples. Some or all of the above-described processing in the provision unit may be performed using generative AI, or may be performed without using generative AI. For example, the provision unit can input data for estimating the user's emotions to a generative AI, and the generative AI can estimate the emotions and adjust the expression method of advice based on the results.

The provision unit can adjust the level of detail of advice based on the importance of the advice when providing advice based on the analysis results. The provision unit can, for example, adjust the level of detail of advice based on the importance of the advice when providing advice based on the analysis results. For important advice, advice containing detailed information is provided. For advice of low importance, advice containing simplified information can be provided. The level of detail can also be adjusted stepwise according to the importance of the advice to provide appropriate advice. By adjusting the level of detail of advice based on the importance of the advice, important advice can be provided in detail. Some or all of the above-described processing in the provision unit may be performed using generative AI, or may be performed without using generative AI. For example, the provision unit can input the analysis results to a generative AI, and the generative AI can adjust the level of detail of advice based on the importance of the advice.

The provision unit can apply different advice algorithms according to the category of the action when providing advice based on the analysis results. The provision unit can, for example, apply different advice algorithms according to the category of the action when providing advice based on the analysis results. For example, a sports-specific advice algorithm is applied to sports actions. A craft-specific advice algorithm can also be applied to craft actions. An art-specific advice algorithm can also be applied to art actions. By applying different advice algorithms according to the category of the action, more appropriate advice can be provided. Some or all of the above-described processing in the provision unit may be performed using generative AI, or may be performed without using generative AI. For example, the provision unit can input the analysis results to a generative AI, and the generative AI can apply different advice algorithms according to the category of the action.

The system comprises a provision unit that estimates the user's emotions and adjusts the length of advice based on the estimated emotions of the user. The provision unit can, for example, estimate the user's emotions and adjust the length of advice based on the estimated emotions. For example, if the user is nervous, short and concise advice is provided. If the user is relaxed, longer advice including detailed explanations can be provided. If the user is focused, advice including technical details can be provided. By adjusting the length of advice according to the user's emotions, more appropriate advice can be provided. Emotion estimation is realized, for example, by using an emotion engine or a generative AI as an emotion estimation function. The generative AI may be, for example, a text generative AI (such as an LLM) or a multimodal generative AI, but is not limited to such examples. Some or all of the above-described processing in the provision unit may be performed using generative AI, or may be performed without using generative AI. For example, the provision unit can input data for estimating the user's emotions to a generative AI, and the generative AI can estimate the emotions and adjust the length of advice based on the results.

The provision unit can determine the priority of advice based on the submission timing of the action when providing advice based on the analysis results. The provision unit can, for example, determine the priority of advice based on the submission timing of the action when providing advice based on the analysis results. For example, advice based on recently captured data is provided with priority. The priority can be lowered for advice based on data with an older submission timing. The priority of advice can also be adjusted stepwise based on the submission timing to provide appropriate advice. By determining the priority of advice based on the submission timing, advice based on the latest data can be provided with priority. Some or all of the above-described processing in the provision unit may be performed using generative AI, or may be performed without using generative AI. For example, the provision unit can input the analysis results to a generative AI, and the generative AI can determine the priority of advice based on the submission timing of the action.

The provision unit can adjust the order of advice based on the relevance of the action when providing advice based on the analysis results. The provision unit can, for example, adjust the order of advice based on the relevance of the action when providing advice based on the analysis results. For example, advice for actions with high relevance is provided with priority. The order can be postponed for advice for actions with low relevance. The order of advice can also be adjusted stepwise based on the relevance of the action to provide appropriate advice. By adjusting the order of advice based on the relevance of the action, advice for actions with high relevance can be provided with priority. Some or all of the above-described processing in the provision unit may be performed using generative AI, or may be performed without using generative AI. For example, the provision unit can input the analysis results to a generative AI, and the generative AI can adjust the order of advice based on the relevance of the action.

The system according to the embodiment is not limited to the above-described examples, and various modifications are possible, for example, as follows.

The system may comprise an audio capture unit that records environmental sounds simultaneously when capturing the user's actions. For example, the sounds around the user while playing sports are recorded and the audio data is analyzed together with the motion analysis. The sounds of tools while the user is performing craft work can also be recorded and used to analyze the accuracy and rhythm of the actions. The sounds of instruments while the user is performing music can also be recorded and used to improve performance skills. By combining and analyzing motion and audio data, more detailed feedback can be provided.

The system may comprise an environmental sensor unit that records environmental data such as temperature and humidity simultaneously when capturing the user's actions. For example, the temperature and humidity around the user while playing sports are recorded and the environmental data is analyzed together with the motion analysis. The temperature and humidity of the work environment while the user is performing craft work can also be recorded and used to analyze factors affecting work efficiency and accuracy. The temperature and humidity of the performance environment while the user is performing music can also be recorded and used to improve performance skills. By combining and analyzing motion and environmental data, more detailed feedback can be provided.

The system may comprise a biometric sensor unit that records biometric data such as heart rate and respiration rate simultaneously when capturing the user's actions. For example, the user's heart rate and respiration rate while playing sports are recorded and the biometric data is analyzed together with the motion analysis. The user's heart rate and respiration rate while performing craft work can also be recorded and used to analyze the degree of concentration and fatigue. The user's heart rate and respiration rate while performing music can also be recorded and used to improve performance skills. By combining and analyzing motion and biometric data, more detailed feedback can be provided.

The system may comprise an eye-tracking unit that records the user's gaze movements simultaneously when capturing the user's actions. For example, the user's gaze movements while playing sports are recorded and the gaze data is analyzed together with the motion analysis. The user's gaze movements while performing craft work can also be recorded and used to analyze the degree of concentration and gaze movement patterns. The user's gaze movements while performing music can also be recorded and used to improve performance skills. By combining and analyzing motion and gaze data, more detailed feedback can be provided.

The system may comprise an electromyography (EMG) sensor unit that records the user's muscle potentials simultaneously when capturing the user's actions. For example, the user's muscle potentials while playing sports are recorded and the EMG data is analyzed together with the motion analysis. The user's muscle potentials while performing craft work can also be recorded and used to analyze the accuracy and force applied during work. The user's muscle potentials while performing music can also be recorded and used to improve performance skills. By combining and analyzing motion and EMG data, more detailed feedback can be provided.

The system may comprise a provision unit that estimates the user's emotions and adjusts the difficulty of actions based on the estimated emotions of the user. For example, if the user is nervous, the difficulty of actions is lowered and emphasis is placed on basic actions. If the user is relaxed, the difficulty of actions can be increased and emphasis can be placed on actions that require advanced techniques. If the user is focused, the difficulty of actions can be adjusted to provide appropriate challenges. By adjusting the difficulty of actions according to the user's emotions, more appropriate training can be provided.

The system may comprise a provision unit that estimates the user's emotions and adjusts the timing of feedback based on the estimated emotions of the user. For example, if the user is nervous, the timing of feedback is delayed to give the user time to relax. If the user is relaxed, the timing of feedback can be advanced to provide immediate points for improvement. If the user is focused, the timing of feedback can be adjusted to provide it at the appropriate timing. By adjusting the timing of feedback according to the user's emotions, more effective feedback can be provided.

The system may comprise a provision unit that estimates the user's emotions and adjusts the content of feedback based on the estimated emotions of the user. For example, if the user is nervous, content with more positive feedback is provided. If the user is relaxed, feedback including specific points for improvement can be provided. If the user is focused, feedback including technical details can be provided. By adjusting the content of feedback according to the user's emotions, more appropriate feedback can be provided.

The system may comprise a provision unit that estimates the user's emotions and adjusts the frequency of training based on the estimated emotions of the user. For example, if the user is nervous, the frequency of training is lowered to increase relaxation time. If the user is relaxed, the frequency of training can be increased to maintain concentration. If the user is focused, the frequency of training can be adjusted to provide an appropriate load. By adjusting the frequency of training according to the user's emotions, more effective training can be provided.

The system may comprise a provision unit that estimates the user's emotions and adjusts the type of training based on the estimated emotions of the user. For example, if the user is nervous, training with a relaxing effect is provided. If the user is relaxed, training to enhance concentration can be provided. If the user is focused, training to improve technical skills can be provided. By adjusting the type of training according to the user's emotions, more appropriate training can be provided.

Below, the processing flow of Example 2 of the Embodiment will be briefly described.

Step 1: The camera unit captures the user's movements. The camera unit can, for example, capture the user's movements or posture in real time. For example, the camera unit can capture the user's movements while walking. The camera unit can also capture the user's movements while running. The camera unit can also capture the user's posture when standing. For example, the camera unit can also capture the user's posture when sitting. Step 2: The analysis unit analyzes the captured data. The analysis unit can, for example, determine how the user's movements or posture differ from those of an expert. For example, the analysis unit can analyze how the user's movement angles and timing differ from those of an expert. The analysis unit can also analyze how the user's movement speed and rhythm differ from those of an expert. The analysis unit can also analyze how the user's posture stability and balance differ from those of an expert. Step 3: The provision unit provides real-time advice based on the analysis results. The provision unit can, for example, provide the user with specific advice such as “It would be better to raise the angle of your movement a little more” or “Make your hand movements a little smoother.” The provision unit can also provide the user with advice such as “Move a little faster” or “Stabilize your posture balance a little more.”

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the above-described elements, including the camera unit, analysis unit, and provision unit, is implemented by at least one of, for example, the smart device 14 and the data processing apparatus 12. For example, the camera unit captures the user's movements and posture in real time using the camera 42 of the smart device 14. The analysis unit analyzes the captured data using the specific processing unit 290 of the data processing apparatus 12 and determines how the user's movements and posture differ from those of an expert. The provision unit provides real-time advice based on the analysis results using the specific processing unit 290 of the data processing apparatus 12. Each of the camera unit, analysis unit, and provision unit may also be implemented by the control unit 46A of the smart device 14. The correspondence between each unit and the device or control unit is not limited to the above examples and various modifications are possible.

### Second Embodiment

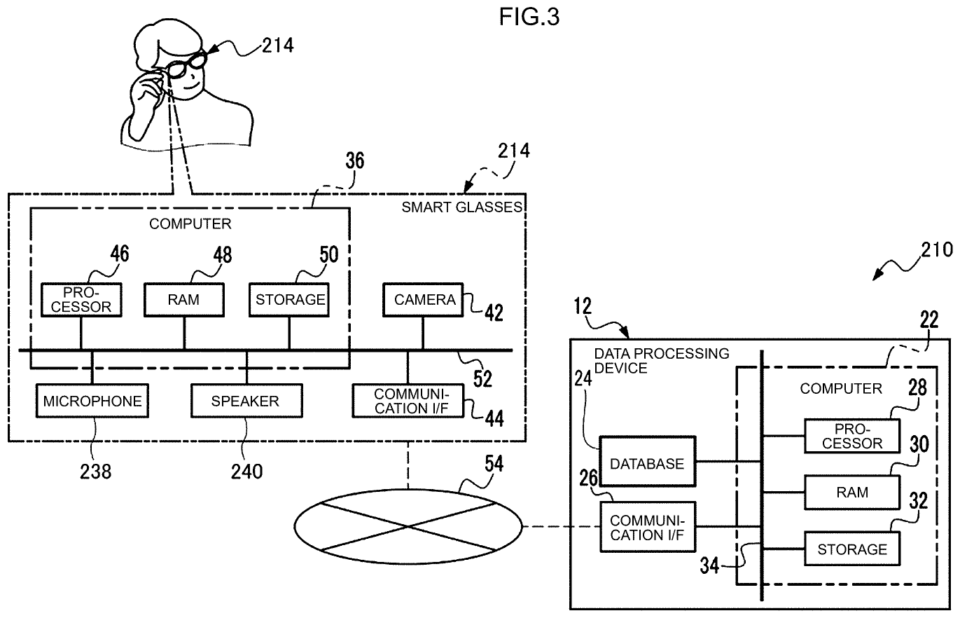

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

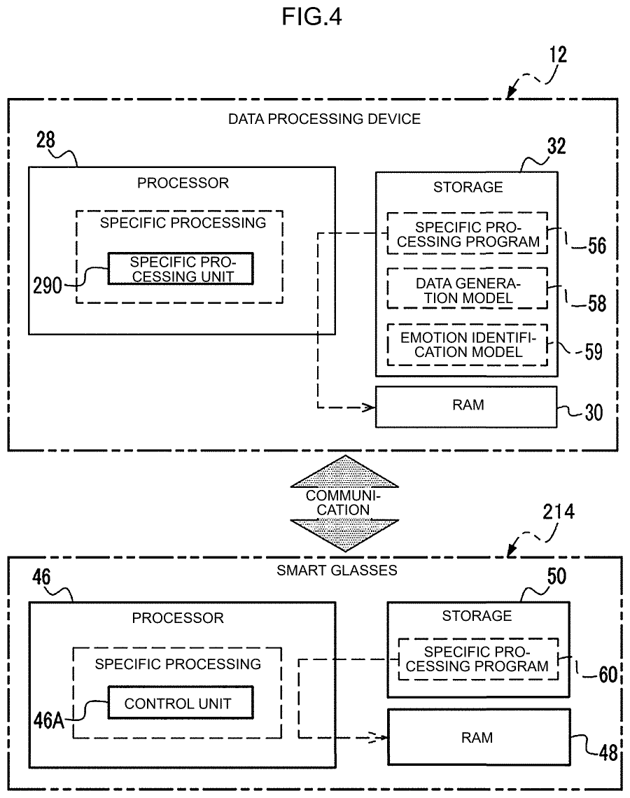

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the above-described elements, including the camera unit, analysis unit, and provision unit, is implemented by at least one of, for example, the smart glasses 214 and the data processing apparatus 12. For example, the camera unit captures the user's movements and posture in real time using the camera 42 of the smart glasses 214. The analysis unit analyzes the captured data using the specific processing unit 290 of the data processing apparatus 12 and determines how the user's movements and posture differ from those of an expert. The provision unit provides real-time advice based on the analysis results using the specific processing unit 290 of the data processing apparatus 12. Each of the camera unit, analysis unit, and provision unit may also be implemented by the control unit 46A of the smart glasses 214. The correspondence between each unit and the device or control unit is not limited to the above examples and various modifications are possible.

### Third Embodiment

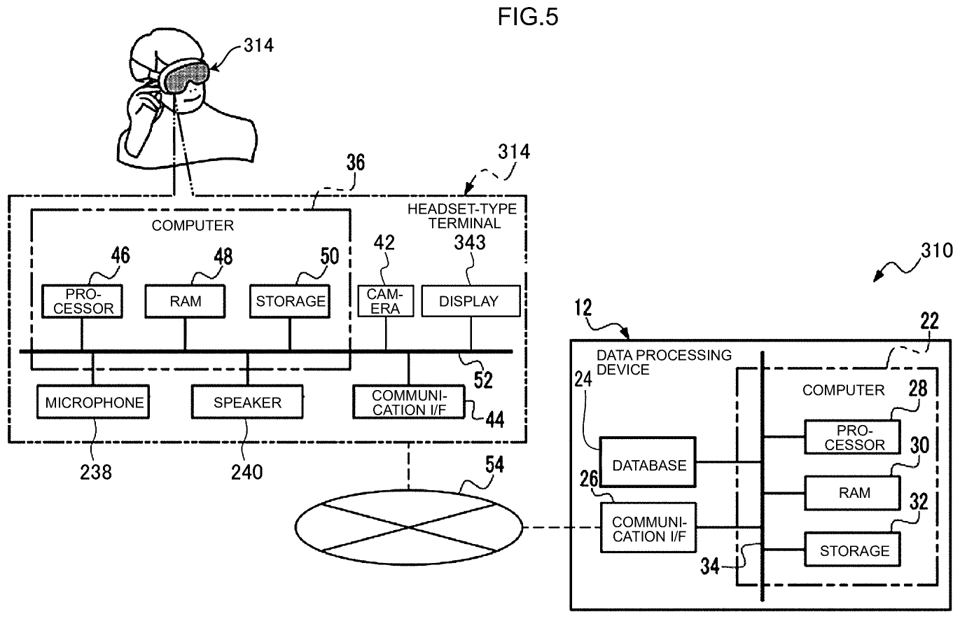

FIG. 5 shows an example configuration of a data processing system 310 according to the third embodiment. As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

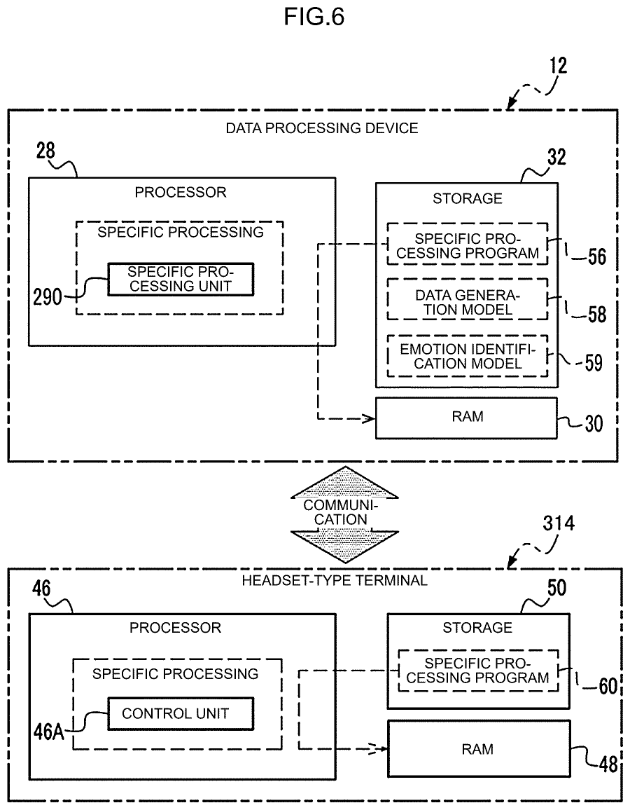

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the above-described elements, including the camera unit, analysis unit, and provision unit, is implemented by at least one of, for example, the headset-type terminal 314 and the data processing apparatus 12. For example, the camera unit captures the user's movements and posture in real time using the camera 42 of the headset-type terminal 314. The analysis unit analyzes the captured data using the specific processing unit 290 of the data processing apparatus 12 and determines how the user's movements and posture differ from those of an expert. The provision unit provides real-time advice based on the analysis results using the specific processing unit 290 of the data processing apparatus 12. Each of the camera unit, analysis unit, and provision unit may also be implemented by the control unit 46A of the headset-type terminal 314. The correspondence between each unit and the device or control unit is not limited to the above examples and various modifications are possible.

### Fourth Embodiment

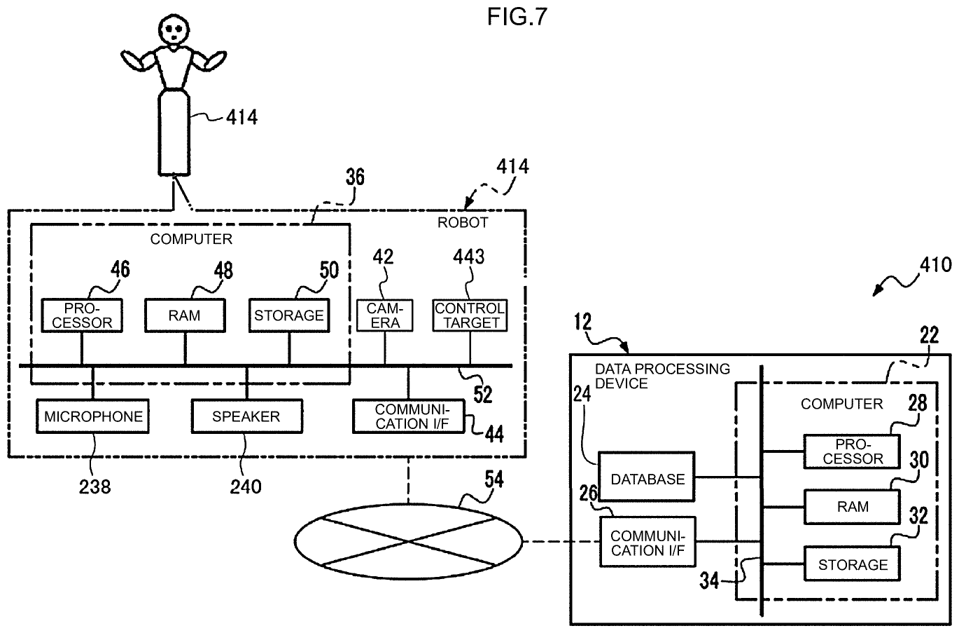

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

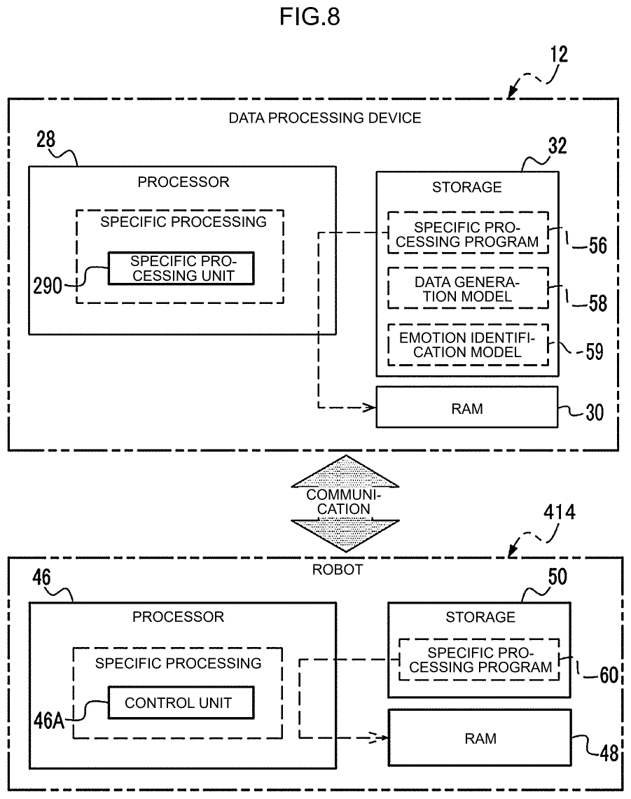

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the above-described elements, including the camera unit, analysis unit, and provision unit, is implemented by at least one of, for example, the robot 414 and the data processing apparatus 12. For example, the camera unit captures the user's movements and posture in real time using the camera 42 of the robot 414. The analysis unit analyzes the captured data using the specific processing unit 290 of the data processing apparatus 12 and determines how the user's movements and posture differ from those of an expert. The provision unit provides real-time advice based on the analysis results using the specific processing unit 290 of the data processing apparatus 12. Each of the camera unit, analysis unit, and provision unit may also be implemented by the control unit 46A of the robot 414. The correspondence between each unit and the device or control unit is not limited to the above examples and various modifications are possible.

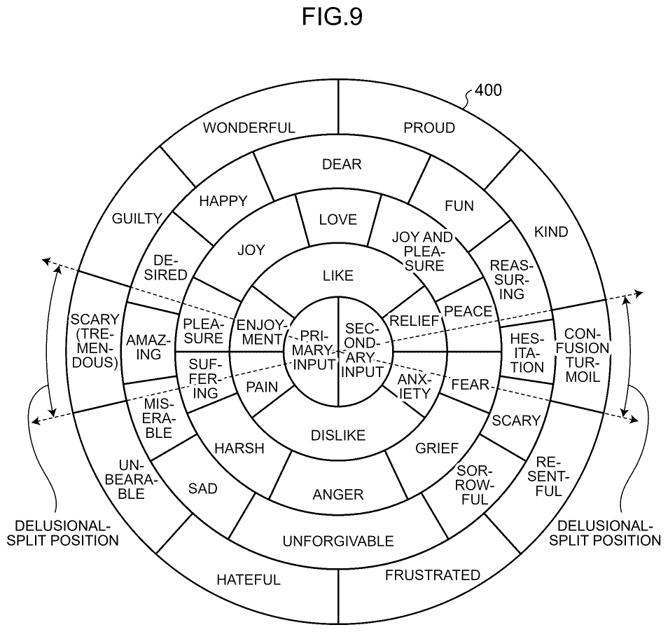

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

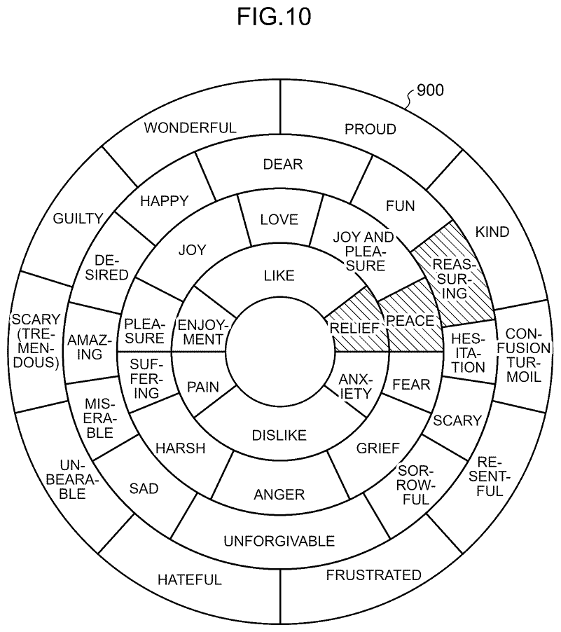

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above.

Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### [Additional Note 1]

A system comprising: a camera unit that captures the user's movements; an analysis unit that analyzes data captured by the camera unit; and a provision unit that provides real-time advice based on the analysis results obtained by the analysis unit.

### [Additional Note 2]

The system according to Additional Note 1, wherein the camera unit captures the user's movements or posture in real time.

### [Additional Note 3]

The system according to Additional Note 1, wherein the analysis unit analyzes the captured data and determines how the user's movements or posture differ from those of an expert.

### [Additional Note 4]

The system according to Additional Note 1, wherein the provision unit provides real-time advice based on the analysis results.

### [Additional Note 5]

The system according to Additional Note 1, wherein the provision unit provides the user with specific advice content.

### [Additional Note 6]

The system according to Additional Note 1, wherein the camera unit estimates the user's emotions and adjusts the camera's capture angle based on the estimated emotions of the user.

### [Additional Note 7]

The system according to Additional Note 1, wherein the camera unit analyzes the user's past operation history and selects an appropriate capture timing.

### [Additional Note 8]

The system according to Additional Note 1, wherein the camera unit emphasizes and captures specific movements or postures when capturing the user's movements.

### [Additional Note 9]

The system according to Additional Note 1, wherein the camera unit estimates the user's emotions and determines the priority of actions to be captured based on the estimated emotions of the user.

### [Additional Note 10]

The system according to Additional Note 1, wherein the camera unit prioritizes capturing actions with high relevance by considering the user's geographic location information.

### [Additional Note 11]

The system according to Additional Note 1, wherein the camera unit analyzes the user's social media activity and captures related actions.

### [Additional Note 12]

The system according to Additional Note 1, wherein the analysis unit estimates the user's emotions and adjusts the analysis algorithm based on the estimated emotions of the user.

### [Additional Note 13]

The system according to Additional Note 1, wherein the analysis unit adjusts the level of detail of the analysis based on the importance of the action when analyzing the captured data.

### [Additional Note 14]

The system according to Additional Note 1, wherein the analysis unit applies different analysis algorithms according to the category of the action when analyzing the captured data.

### [Additional Note 15]

The system according to Additional Note 1, wherein the analysis unit estimates the user's emotions and adjusts the display method of the analysis results based on the estimated emotions of the user.

### [Additional Note 16]

The system according to Additional Note 1, wherein the analysis unit determines the priority of analysis based on the submission timing of the action when analyzing the captured data.

### [Additional Note 17]

The system according to Additional Note 1, wherein the analysis unit adjusts the order of analysis based on the relevance of the action when analyzing the captured data.

### [Additional Note 18]

The system according to Additional Note 1, wherein the provision unit estimates the user's emotions and adjusts the expression method of advice based on the estimated emotions of the user.

### [Additional Note 19]

The system according to Additional Note 1, wherein the provision unit adjusts the level of detail of advice based on the importance of the advice when providing advice based on the analysis results.

### [Additional Note 20]

The system according to Additional Note 1, wherein the provision unit applies different advice algorithms according to the category of the action when providing advice based on the analysis results.

### [Additional Note 21]

The system according to Additional Note 1, wherein the provision unit estimates the user's emotions and adjusts the length of advice based on the estimated emotions of the user.

### [Additional Note 22]

The system according to Additional Note 1, wherein the provision unit determines the priority of advice based on the submission timing of the action when providing advice based on the analysis results.

### [Additional Note 23]

The system according to Additional Note 1, wherein the provision unit adjusts the order of advice based on the relevance of the action when providing advice based on the analysis results.

What is claimed is:

1. A system comprising: a camera unit that captures the user's movements; an analysis unit that analyzes data captured by the camera unit; and a provision unit that provides real-time advice based on the analysis results obtained by the analysis unit.

2. The system according to claim 1, wherein the camera unit captures the user's movements or posture in real time.

3. The system according to claim 1, wherein the analysis unit analyzes the captured data and determines how the user's movements or posture differ from those of an expert.

4. The system according to claim 1, wherein the provision unit provides real-time advice based on the analysis results.

5. The system according to claim 1, wherein the provision unit provides the user with specific advice content.

6. The system according to claim 1, wherein the camera unit estimates the user's emotions and adjusts the camera's capture angle based on the estimated emotions of the user.

7. The system according to claim 1, wherein the camera unit analyzes the user's past operation history and selects an appropriate capture timing.

8. The system according to claim 1, wherein the camera unit emphasizes and captures specific movements or postures when capturing the user's movements.
